(19) United States
(12) Patent Application Publication
(10) Pub. No.: US 2011/0035876 A1
(43) Pub. Date: Feb. 17, 2011

(54) Human body supporting apparatus

(76) Inventor: Cherng-Shiow Chang, Taipei City (TW)

Correspondence Address: Tung & Associates, Suite 120, 838 W. Long Lake Road, Bloomfield Hills, MI, 48302, US

(21) Appl. No.: 12/806,230

(22) Filed: Aug. 6, 2010

(30) Foreign Application Priority Data
Aug. 17, 2009 (TW) 098215150

(51) Int. Cl. A61G 7/10

(52) U.S. Cl. 5/81.1 R

(57) ABSTRACT

The present invention discloses a human body supporting apparatus, comprising: a main body, and an armrest member, wherein the armrest member is connected with the main body, and includes an extensible member. The extensible member includes a moving assisting status and a closed status, wherein the extensible member is unfolded and connected with the main body in the moving assisting status. According to the present invention, a patient can be moved by less force and simpler process via the foregoing extensible members operated in the moving assisting status.

### CROSS REFERENCE

The present invention claims priority to TW 098215150, filed on Aug. 17, 2009.

### BACKGROUND OF THE INVENTION

1. Field of Invention

The present invention relates to a human body supporting apparatus, and particularly to a human body supporting apparatus with an extensible member facilitating movement of a patient or an injured person between two locations.

2. Description of Related Art

When a patient is to be moved from a human body supporting apparatus (e.g., a wheelchair or a bed) to a nearby place or another human body supporting apparatus, a medical staff has to take hold of the patient, lift him/her from one side, and move him/her. This is a difficult and laborious task, and furthermore it increases the risk of hurting the patient (and the medical staff as well). An improved method proposed by prior art is to place a short hard plate between two locations, one or both of which may be the human body supporting apparatuses, such that the patient can sit on the plate and shift himself/herself to the destiny easier. Although this method reduces the risk of hurting the patient during movement, not every patient can sit on the plate and move himself/herself; hence, the effect that such plate can provide is very limited. In addition, the plate requires a storage space, and if such space is not available in the human body supporting apparatus, it would be very inconvenient for the patient or one who takes care of the patient to carry it everywhere the patient goes; most likely the plate will be lost. Besides, such moving aid by a short hard plate can not be applied to most wheelchairs because the armrests of the wheelchairs hinder the patients' movement. In view of the foregoing, it is desired to provide a human body supporting apparatus which facilitates moving a patient between the apparatus and another place, while reducing the risk of injury to both the patent and the one who takes care of the patient.

### SUMMARY OF THE INVENTION

In view of the foregoing, an objective of the present invention is to provide a human body supporting apparatus, which includes an extensible member to provide a guide way for moving a patient or an injured person, so as to facilitate moving operation and to reduce the risk of injury to both the patent and the one who takes care of the patient.

To achieve the above and other objectives, the present invention provides a human body supporting apparatus comprising: a main body, and an armrest member connected with the main body, wherein the armrest member includes at least one extensible member. The extensible member is convertible between a moving assisting status and a closed status, wherein in the moving assisting status the extensible member is connected with the main body and extended from the main body to forma guide way such that a human body can be moved between the human body supporting apparatus and another position along the guide way. As such, a patient can be moved by less effort and simpler operation.

According to the present invention, the human body supporting apparatus can be applied to a wheelchair, a bed, a stretcher, or other apparatuses for patient care.

The objectives, technical details, features, and effects of the present invention will be better understood with regard to the detailed description of the embodiments below, with reference to the drawings.

### BRIEF DESCRIPTION OF THE DRAWINGS

FIG. 1 shows a human body supporting apparatus according to an embodiment the present invention.

FIG. 2 shows that an extensible member of the human body supporting apparatus is in a moving assisting status.

FIG. 3 shows that the extensible member of the human body supporting apparatus provides an aid to moving a human body.

FIG. 4 shows that a human body supporter unit of the human body supporting apparatus provides a further aid to moving a human body.

### DESCRIPTION OF THE PREFERRED EMBODIMENTS

The present invention can be more clearly understood from the following description with respect to specific embodiments.

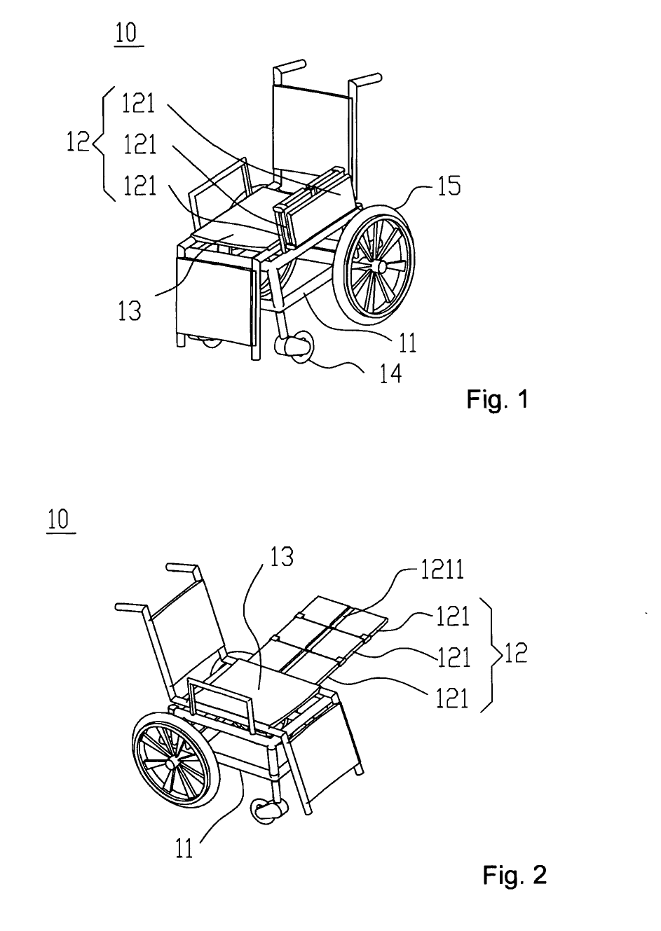

Please refer to FIG. 1, which shows a human body supporting apparatus 10 according to the present invention. The human body supporting apparatus 10 comprises a main body 11, and at least one armrest connected with the main body 11. The human body supporting apparatus 10 for example can be a wheelchair having two armrests, as shown in FIG. 1, but can instead be a bed or a stretcher. The main body 11 may also be connected with a seat 13, and the two armrests are located at both sides of the seat 13. In one embodiment, one of the armrests includes an extensible member 12. The extensible member 12 is convertible between a moving assisting status and a closed status, wherein when the extensible member 12 is in use, i.e., in the moving assisting status, the extensible member 12 provides a guide way to facilitate moving a human body, as shown in FIG. 2; if the extensible member 12 is not in use, i.e., in the closed status not for moving a human body, the extensible member 12 is as shown in FIG. 1. The extensible member 12 includes at least one connection part 121. Preferably, the extensible member 12 includes multiple connection parts 121 each of which can be a plane structure or a plate structure. When the extensible member 12 is not in use for moving a human body, i.e., in the closed status, the extensible member 12 is folded and accommodated in the main body 11 at one side of the seat 13, as shown in FIG. 1. If the human body supporting apparatus 10 is a wheelchair, the main body 11 may further include a direction-control member 14 (e.g., a smaller wheel set rotatable along z-axis) for controlling the direction of the wheelchair and a main wheel set 15 to assist moving of the wheelchair. The function and structure of the direction-control member 14 and wheel set 15 are not described here in detail because they are well known in this art.

Please refer to FIG. 2, which shows the extensible member 12 operating in the moving assisting status. When the extensible member 12 is in use, i.e., in the moving assisting status as shown in FIG. 2 for moving a human body, the connection part 121 is converted from an upright position to an outwardly extended position where it extends outwardly from the main body 11 to form a guide way, and preferably the connection part 121 is maintained at about the same level as the seat 13. If the extensible member 12 includes multiple connection parts 121, the connection parts 121 can be connected one to another in a sequence as shown in the drawing, that is, each connection part 121 is connected in series with an adjacent connection part 121. Preferably, at least one of the connection parts 121 has an assisting rail 1211 connectible with a corresponding connection member (to be described later), such that the human body can be moved more safely and comfortably thereby. Note that the number of the connection parts 121 can be modified and it is not limited to the number as shown in the drawing.

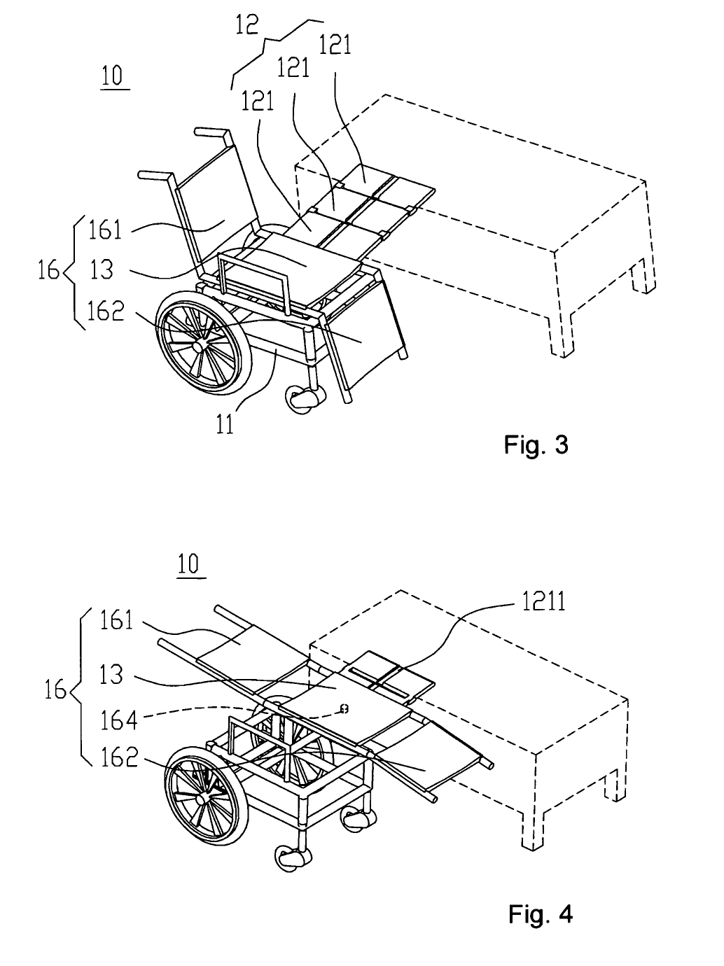

Next please refer to FIG. 3, which shows an application of the human body supporting apparatus 10. In the moving assisting status, the extensible member 12 forms a guide way which reaches to another supporting apparatus (such as a bed as shown by dashed lines in FIG. 3), and a human body (not shown) can be moved from the human body supporting apparatus 10 to this bed along the guide way formed by the extensible member 12. Furthermore, the human body supporting apparatus 10 can further include a human body supporter unit 16 which is connected with the main body 11 in a detachable manner, wherein the human body supporter unit 16 is convertible between a human body conveying status and a normal status. FIG. 3 shows the normal status of the human body supporter unit 16, and FIG. 4 shows the human body conveying status of the human body supporter unit 16. In one preferable embodiment shown in FIG. 3, the human body supporter unit 16 includes a back 161, a seat 13, and a leg support 162; in the normal status, the back 161 and leg support 162 are uprightly connected with the seat 13 for best support of a human in sitting position. The human body supporter unit 16 may further include a pedal (not shown).

Please refer to FIG. 4, which shows the human body supporter unit 16 in the human body conveying status. In this human body conveying status, the back 161, seat 13, and leg support 162 are unfolded and are at about the same level, to best support a human in lying position. The human body supporter unit 16 may further include at least one connection member 164, provided for example but not necessarily at the underside of the seat 13, for connection with the assisting rail 1211 in correspondence. Thus, a medical staff can move a patient from the human body supporting apparatus 10 to another supporting apparatus (as shown by the dashed lines in FIG. 4) more easily with the aid by the human body supporter unit 16. The connection member 164 for example may be one or more studs or wheels.

In the above embodiment, the human body supporting apparatus 10 of the present invention is shown as a wheelchair, but it is not limited to it. The present invention can be applied to any other human body supporting apparatus, such as a bed or a stretcher.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, both of the armrests may be provided with the extensible members. For another example, the assisting rail 1211 and the connection member 164 can be interchanged such that the human body supporter unit 16 is provided with the connection member 164 while the connection part 121 is provided assisting rail 1211; or, the human body supporter unit 16 and the connection part 121 can be interconnected with each other by any other suitable means. In view of the foregoing, the spirit of the present invention should cover all such and other modifications and variations, which should be interpreted to fall within the scope of the following claims and their equivalents.

What is claimed is:

1. A human body supporting apparatus, comprising:
a main body, and
an armrest member connected with the main body, the armrest member including at least one extensible member convertible between a moving assisting status and a closed status, wherein in the moving assisting status the extensible member is connected with the main body and extended from the main body to form a guide way such that a human body can be moved between the human body supporting apparatus and another position along the guide way.

2. The human body supporting apparatus of claim 1, further comprising a seat connected with the main body, wherein in the moving assisting status, the extensible member is extended from the main body and maintained at about the same level as the seat.

3. The human body supporting apparatus of claim 1, wherein the extensible member includes a plurality of connection parts connected with one another such that the extensible member is convertible between a folded status and an unfolded status.

4. The human body supporting apparatus of claim 3, wherein each of the connection parts is connected in series with an adjacent connection part in the unfolded status.

5. The human body supporting apparatus of claim 3, wherein the plurality of connection parts are folded and accommodated in the main body in the folded status.

6. The human body supporting apparatus of claim 1, wherein the extensible member has an assisting rail.

7. The human body supporting apparatus of claim 1, wherein in the closed status the extensible member is uprightly connected to the main body.

8. The human body supporting apparatus of claim 1, wherein the main body further includes a direction-control member and a wheel set.

9. The human body supporting apparatus of claim 1, further comprising: a human body supporter unit connected with the main body, wherein the human body supporter unit is convertible between a human body conveying status and a normal status.

10. The human body supporting apparatus of claim 9, wherein the human body supporter unit includes a back, a seat connected with the back, and a leg support connected with the seat, wherein the back, seat and leg support are at about the same level in the human body conveying status.

11. The human body supporting apparatus of claim 9, wherein the human body supporter unit includes a connection member for connecting with a corresponding rail.

12. The human body supporting apparatus of claim 10, wherein the back and leg support are uprightly connected with the seat in the normal status.

13. The human body supporting apparatus of claim 1, wherein the human body supporting apparatus is one of the followings: a wheel chair, a bed, and a stretcher.
